(19) United States
(12) Patent Application Publication
(10) Pub. No.: US 2014/0162094 A1
(43) Pub. Date: Jun. 12, 2014

(54) ELECTROCHEMICAL ELEMENT

(71) Applicants: Atsushi Nishino, Neyagawa-shi (JP); Ryousuke Dohi, Osaka-shi (JP); Nobukazu Ikeda, Osaka-shi (JP); Kouji Nishino, Osaka-shi (JP); Seichin Kinuta, Ashikaga-shi (JP); Yoshiaki Saita, Ashikaga-shi (JP); Masashi Kobayashi, Ashikaga-shi (JP)

(72) Inventors: Atsushi Nishino, Neyagawa-shi (JP); Ryousuke Dohi, Osaka-shi (JP); Nobukazu Ikeda, Osaka-shi (JP); Kouji Nishino, Osaka-shi (JP); Seichin Kinuta, Ashikaga-shi (JP); Yoshiaki Saita, Ashikaga-shi (JP); Masashi Kobayashi, Ashikaga-shi (JP)

(73) Assignees: OPTNICS PRECISION CO., LTD., Ashikaga-shi, Tochigi (JP); FUJIKIN INCORPORATED, Osaka-shi, Osaka (JP)

(21) Appl. No.: 14/126,445

(22) PCT Filed: Jun. 13, 2012
(86) PCT No.: PCT/JP2012/065161

§ 371 Date: Feb. 26, 2014

(30) Foreign Application Priority Data
Jun. 17, 2011 (JP) 2011-135806

(51) Int. Cl. H01G 11/04; H01M 2/36

(52) U.S. Cl. CPC H01G 11/04; H01M 2/361
USPC 429/72; 361/502

(57) ABSTRACT

The purpose of the present invention is to provide an electrochemical element to which a high-concentration and high-viscosity electrolyte is supplied. The electrolyte is dispersed and supplied instantaneously to the electrochemical element in a small fixed quantity.

### TECHNICAL FIELD

The present invention relates to an ultra-small electrochemical element such as an ultra-small secondary cell, an ultra-small primary cell, an ultra-small electric double layer capacitor, and an ultra-small pseudo double layer capacitor. In particular the present invention relates to an electrochemical element that employs a novel electrolyte liquid injection method that is capable of performing rapid metered supply of various high concentration electrolytes accurately in minute amounts to give penetrant diffusion into cathode and anode mixtures of an electrochemical element.

### BACKGROUND ART

A mobile phone called a smartphone is a mobile device designed to make a conventional mobile phone multi-functional, such as with personal computer functions, email functions, game functions, electronic book functions and music functions. Typical of such devices is an i-Phone produced by Apple Corporation, a mobile device that has started to be adopted in the USA from about 2007, and that rapidly started to spread from about 2008 in Korea and from about 2009 in Japan.

In these new types of mobile phone, as a power back up, originally a ML battery (MnO₂/Li primary cell) was employed, but along with increasing functionality of mobile phones, the mobile phones are becoming higher in cost and the usage time of the high cost mobile phones is becoming a long period of time, and due to there being insufficient battery capacity, battery durability, and voltage and current at the time when the software is instantly started up, from about 2008 there has been a shift over from coin type ML batteries to ultra-small electric double layer capacitors of coin or chip type (referred to below as EDLC). Such small coin types are produced mainly in Japan and Korea at a range of about 200,000,000 per month, however there is still a product shortage.

Among difficulties in mass production, currently there is a large problem in the metered supply of minute amounts of ionic liquids at high concentrations, such as EMIBF4 (ethyl-methyl imidazolium tetrafluoroborate), and in making high viscosity electrolytes disperse and be absorbed in the electrode mixtures of electrochemical elements within a short period of time. In order to achieve the relatively large currents required in the most recent mobile phones, high concentration electrolytes with low resistance and ionic liquids that can withstand solder reflow are being employed neat (at 100%). The viscosity of such high concentration electrolytes at 20° C. is a high viscosity of 15 to 35 mPa·s (15 to 35 cps), such that conventional known methods of liquid injection cannot be employed.

In conventional battery manufacture, plunger pumps, needle valves and micro syringes are frequently employed for liquid injection in cylindrical and square shaped batteries. In conventionally employed liquid injection methods of simply droplet-dripping under conditions of normal temperature and pressure, bubbles remain on surfaces such as electrode sets and separators, and electrolyte overflows from the battery case during liquid injection, and problem arises that insufficient penetration of the electrolyte into the electrode sets and battery case is achieved, or the time taken for liquid injection becomes too long.

As countermeasures thereto, splitting up liquid injection into plural sessions, liquid injection at raised electrolyte temperature, employing centrifugal force after liquid injection and reduced pressure processing have been performed, however all of these take up effort and time. For example known methods include a reduced pressure exchange liquid injection method which is a method in which, after removing air from within a battery container and removing bubbles in an electrolyte within a storage cup inside a vacuum chamber, liquid injection is then performed whilst gradually increasing the atmospheric pressure within the vacuum chamber (see Patent Document 1), and also a method in which pressure inside a battery case is reduced by using a vacuum pump, and then electrolyte is suctioned in and injected by using a three-way valve to place the inside of the battery case in communication with an electrolyte storage tank (see Patent Document 2).

As other liquid inject methods, a device in which a nozzle plate with a multitude of fine nozzles is vibrated by a piezoelectric vibrator, and liquid supplied to the nozzle plate is sprayed from the nozzles, and a device in which a liquid is supplied between a nozzle plate with a multitude of fine nozzles and an adjacent ultrasound vibrator sprays the liquid from the nozzles, are recently being employed widely in medical nebulizers (inhalers), humidifiers, and in aroma diffusers and atomizers of moisturizing liquids due to their characteristics of compact size and low energy requirements.

As such atomizing spray devices, there are descriptions of devices that intermittently diffuse in order to diffuse fine particles sprayed from nozzles (see Patent Document 3), and devices that intermittently drive a vibrator to save on power or to limit power to a vibrator (see Patent Document 4 and Patent Document 5).

Moreover, in relation to technology for ejecting high viscosity liquid as liquid droplets from nozzles, there is a description of technology that imparts the large shearing force that is required to shear liquid droplets for ejection (see Patent Document 6), and there is a description of technology that reduces the viscosity of a high viscosity liquid such as by using temperature so as to facilitate ejection from nozzles (see Patent Document 7). However, in the various conventional examples of atomizing devices listed above, since all are mainly directed towards substances with a low viscosity equivalent to diluted water solvents such as inks employed in printers, they have not been implemented in atomizing devices for ionic liquids, vaccines, oils and the like of high viscosity liquids of 10 mPa·s (10 cps) or greater.

A typical conventional example of a liquid injection method is illustrated in FIG. 9. A cathode mixture 2 is housed (at a thickness of 400 to 700 μm) in a stainless steel (SUS 304) cap 1 of a 414 coin type EDLC (3.8 mm diameter×1.4 mm thickness). An ionic liquid has been supplied into this mixture using a liquid injection method such as a syringe. In this conventional method it is possible to supply a conventional electrolyte such as TEABF4. However, an ionic liquid capable of resisting solder reflow such as EMIBF4 has a high viscosity and a large surface tension, and since an electrolyte 3 does not disperse and penetrate into the mixture even when droplet-dripped, the temperature of the droplet dripping environment is raised, and pressure reduction and pressure increase are performed in order to supply the electrolyte.

### PRIOR ART DOCUMENTS

### Patent Documents

Patent Document 1: Japanese Patent Application Laid-Open (JP-A) No. H8-273659
Patent Document 2: JP-A No. H8-298110

### Patent Document 3: JP-A No. 2002-536173

### Patent Document 4: JP-A No. 2000-271517

### Patent Document 5: JP-A No. 2005-511275

### Patent Document 6: JP-A No. 2010-142737

### Patent Document 7: JP-A No. 2003-220702

### SUMMARY OF INVENTION

### Technical Problem

Examples are listed below of problems with conventional methods. Applications for secondary cells have recently been increasing, from small application equipment such as mobile phones to large application equipment such as cars, cranes and construction machinery, and with the increasing functionality of portable computers and mobile devices typified by smart phones, there is demand for low resistance in ultra-small EDLCs, and for extremely rapid electrical charging and discharging with large currents. In particular, for ultra-small EDLCs, there is demand for surface mounting (MSD) functionality, and it is extremely difficult to achieve accurate minute metered supply amounts (from 0.1 to 10 μL/time) since concentrations of ionic liquid EMIBF4 required for supply to achieve solder reflow conditions (260° C.×10 seconds) are 100% (referred to as neat). Overflowing and leaks of EDLC result when there is variation in supply amount, leading to equipment damage. Moreover, the concentrated electrolyte has a high surface tension, so that penetration into the electrode mixtures of the EDLC is difficult and takes time, such that in practice during electrolyte supply production is performed by raising the temperature and using repeating cycles of pressure reduction and pressure increase.

There are also the following problems.

1) With secondary cells and EDLC, there are an increase in low resistance, high current discharge applications, with the electrolyte becoming more concentrated, and sometimes precipitation of crystals occurs during production.
2) There are demands for higher production speed from line speeds of 50 PPM to 100 to 120 PPM.
3) The cost of ultra-small EDLCs was initially 90 to 110 yen/unit, however with the growing market there is demand for cost reductions to 10 to 12 yen/unit.
4) There is demand to shift the production environment from a clean room to a −65° C. dry room environment.

Conventional liquid injection method issues can be broadly split into two. Namely, the issue of technology to make fine particles of high viscosity electrolyte and the issue of technology to make such fine particles rapidly absorb and diffuse into electrode mixtures of an electrochemical element. In detail:

1) The Issue of Atomizing Technology: the viscosity of organic ionic liquids and high concentration electrolytes is 10 to 40 mPa·s (10 to 40 cps). Up till now the atomization and supply of high viscosity liquids has not been possible with known atomizing devices since they are for water based, low viscosity liquids like ink at 10 mPa·s (10 cps) or lower.
2) The Issue of High Viscosity Atomized Fine Particle Diffusion: In an organic high concentration electrolyte, since high purities are employed with contained water at 10 ppm or less, it is difficult to achieve very quick diffusion and absorption of the droplet particles into the electrode mixture and separator of the electrochemical element due to the high viscosity and surface tension, and so it is difficult to achieve a gas-liquid replacement reaction with absorbed air and absorbed gas in the mixture.
Such demands for rapid scaling up for mass production and cost reductions give rise to an urgent need for a revolutionary method that achieves both rapid and accurate metered supply of high concentration electrolyte.

In order to solve the various conventional problems, an object of the present invention is to provide a novel electrochemical element capable of injecting high concentration and high viscosity electrolytes.

### Solution to Problem

A first aspect of the present invention is an electrochemical element wherein predetermined minute amounts of an electrolyte are rapidly supplied with dispersed condition, such that high concentration and high viscosity electrolyte can be rapidly metered and supplied to an electrochemical element.

A second aspect of the present invention is an electrochemical element that can be applied to any one of a primary cell, a secondary cell, an electric double-layer capacitor, or a pseudo electric double-layer capacitor.

A third aspect of the present invention is wherein the electrolyte with a high viscosity of 10 to 40 mPa·s (10 to 40 cps) at 20° C. is supplied to the electrochemical element.

A fourth aspect of the present invention is one wherein a vibration element is employed to intermittently supply the electrolyte from nozzles with spray holes at a density of 1 to 6000 holes/cm² as a means for the dispersion and metered supply, so as to cause a high concentration and high viscosity electrolyte to penetrate and diffuse into an electrode mixture of the electrochemical element.

In a fifth aspect of the present invention, by making fine hole diameters in a range of 1 to 100 μm for nozzles formed in a nickel based alloy metal, nozzles are able to be produced using electroforming technology, enabling electrolyte to be accurately metered and supplied at a minute amount of 0.1 to 10 μL/each time, such that an electrolyte with a high viscosity such as EMIBF4 can be rapidly supplied, and caused to diffuse and penetrate into the electrode mixture.

In a sixth aspect of the present invention, durability can be imparted by performing surface treatment to the surface of the spray holes of the nozzles to achieve excellent abrasion resistance properties, chemical resistance properties and non-wetting resistance properties.

In a seventh aspect of the present invention, water repelling properties are imparted by diamond-like carbon (DLC) processing or fluoro-processing being performed as the surface processing to the nozzle spray holes.

In an eighth aspect of the present invention, by making a duration of the vibration 20 ms or less when the viscosity of the electrolyte is 10 mPa·s (10 cps) or above, and the duration of the vibration 10 ms or less when the viscosity of the electrolyte is 30 mPa·s (30 cps) or above, cessation of atomization and spraying is avoided even with high viscosity electrolytes.

A ninth aspect of the present invention, further includes: a nozzle plate that contains the nozzles and is supplied with the electrolyte; and includes an atomizing spray device for the dispersed and metered supply that includes a vibrator that vibrates the nozzles and a means for generating an electrical signal that intermittently vibrates the vibrator, wherein the atomizing spray device intermittently stops the vibration of the vibrator before a spray outlet side of the nozzles is wetted and covered by the electrolyte, such that by intermittently metering and supplying the electrolyte to the electrochemical element, and causing penetrant diffusion of a high concentration and high viscosity electrolyte into an electrode mixture of the electrochemical element.

In a tenth aspect of the present invention, by the atomizing spray device including a detection means that detects the temperature of the electrolyte, and a determination means that determines the length of the electrical signal according to the detected temperature, wherein an electrolyte amount that is atomized and sprayed from the nozzles is controlled by the length of the electrical signal, the duration of vibration and stopping of the vibrator is accurately controlled according to the viscosity of the liquid, thereby enabling atomizing and spraying to be achieved even for a high viscosity electrolyte.

### Advantageous Effects of Invention

In an eleventh aspect of the present invention, by the nozzle plate having a separation between the adjacent nozzles of 150 μm or greater, forming of a liquid film connecting together nozzles on the spray outlet side so as to stop atomization and spraying is avoided.

As explained above, according to the electrochemical element of the first aspect of the present invention, the surface tension is made smaller by the electrolyte being intermittently droplet-dripped as fine particles. This thereby enables penetrant diffusion of the electrolyte between the mixture particles. Consequently, even for electrolytes of high viscosity that are ionic liquids of high viscosity, wetting is facilitated and continuous release of absorbed gas in the mixture to outside the binder accompanying penetration of the ionic liquid is facilitated, such that there is high speed penetrant diffusion into the electrode mixture. This thereby enables the advantageous effect to be obtained of rapid metered supply of high concentration, high viscosity electrolyte to the electrochemical element.

Moreover, this thereby solves the problem of the conventional example, wherein due to the large surface tension for large droplet particles of high viscosity the electrolyte cannot penetrate into the mixture even after droplet-dripping.

According to an electrochemical element of the second aspect, the advantageous effect is obtained of enabling application to a primary cell, a secondary cell, an electric double-layer capacitor, or a pseudo electric double-layer capacitor.

According to an electrochemical element of the third aspect, the advantageous effect is obtained of enabling supply to be secured of electrolyte having a high viscosity of 10 to 40 mPa·s (10 to 40 cps) at 20° C., which could not be supplied using conventional technology.

According to an electrochemical element of the fourth aspect, due to intermittently supplying the electrolyte from nozzles as a means for dispersion and metered supply, the advantageous effect is obtained of enabling the high concentration, high viscosity electrolyte to be penetration dispersed in an electrode mixture of an electrochemical element.

According to an electrochemical element of the fifth aspect, nozzles that are employed as a means for dispersion and metered supply can be manufactured by electroforming technology, enabling the advantageous effect to be obtained of enabling a minute amount of 0.1 to 10 μL/time to be reliably metered and supplied, and enabling rapid supply of a high viscosity electrolyte such as EMIBF4 and dispersion and penetration into the electrode mixture.

According to an electrochemical element of the sixth aspect, the advantageous effect is obtained of enabling durability to be imparted, thereby giving excellent antifriction characteristics, chemical resistance and non-wetting properties to the surface of spray outlets of nozzles employed as a means for dispersion and metered supply.

According to an electrochemical element of the seventh aspect, by imparting good water release properties to the surface of spray outlets of nozzles employed as a means for dispersion and metered supply, the advantageous effect is obtained of making it difficult for liquid droplets of ejected electrolyte to adhere to the surface of the spray outlets of the nozzles and enabling rapid metered supply to be achieved of high concentration, high viscosity electrolyte to the electrochemical element.

According to an electrochemical element of the eighth aspect, due to the electrolyte less readily forming liquid droplets and therefore more readily adhering to the nozzle plate as viscosity gets higher, and due to the amount of adhered electrolyte increasing gradually with each vibration, the advantageous effect is obtained of enabling cessation of atomization and spraying to be avoided even for high viscosity electrolytes by making the duration of vibration shorter as the viscosity gets higher.

According to the electrochemical element of the ninth aspect, blocking of the nozzles can be suppressed even for high viscosity electrolyte, liquid droplet generation from the nozzles can be continued with unimpeded atomization and spraying, however, by still using a simple structure as a liquid supply structure and atomization and spray structure, without denaturing or breaking down the electrolyte, to give the advantageous effect of enabling not only low viscosity but also in particular high viscosity electrolytes to be atomized and sprayed.

According to an electrochemical element of the tenth aspect, the advantageous effect is exhibited of enabling appropriate control to be performed depending on the temperature of the liquid during the periods of vibration and stopping vibration of the vibrator, enabling atomization and spraying to be achieved even for a high viscosity electrolyte.

According to an electrochemical element of the eleventh aspect, the advantageous effect is exhibited of enabling prevention of cessation of atomization and spraying occuring due to a liquid film connecting between nozzles on the spray outlet side when the distance between nozzles is too short.

### BRIEF DESCRIPTION OF DRAWINGS

FIG. 1 is an explanatory diagram of electrolyte supply to an electrochemical element illustrating a first exemplary embodiment of the present invention.

FIG. 2 is an explanatory diagram of electrolyte supply to an electrochemical element illustrating a second exemplary embodiment of the present invention.

FIG. 3 is a cross-section of an atomizing spray device illustrating the first exemplary embodiment that supplies electrolyte to the electrochemical element of the present invention.

FIG. 4 is a diagram illustrating a pulse wave form in the first exemplary embodiment of the present invention.

FIG. 5 is diagram illustrating an atomization operation of the first exemplary embodiment of the present invention.

FIG. 6 is a cross-section of an atomizing spray device illustrating the second exemplary embodiment that supplies electrolyte to an electrochemical element of the present invention.

FIG. 7 is a cross-section of an atomizing spray device illustrating a third exemplary embodiment that supplies electrolyte to the electrochemical element of the present invention.

FIG. 8 (FIGS. 8A, 8B and 8C) is a diagram illustrating characteristic evaluation between the present invention and conventional examples.

FIG. 9 is an explanatory diagram of electrolyte supply to an electrochemical element of a conventional example.

### DESCRIPTION OF EMBODIMENTS

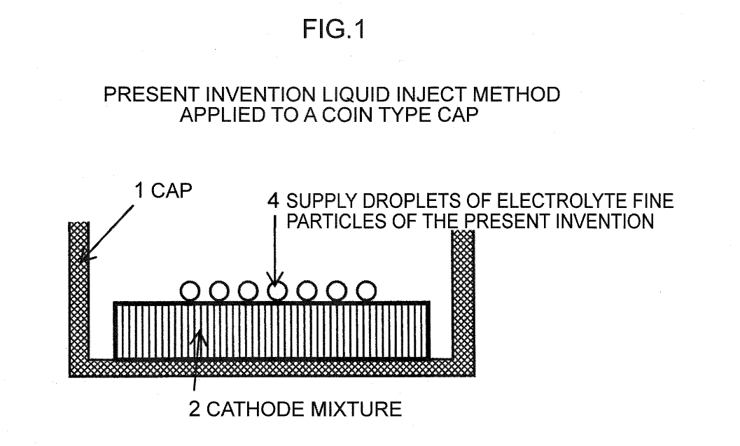

Detailed explanation follows regarding exemplary embodiments of the present invention, based on FIG. 1 to FIG. 8. First details are given of a basic structure of an atomizing spray device, and then details are given of an ultra-small EDLC coin as an example of application to an electrochemical element.

Atomizing Spray Device

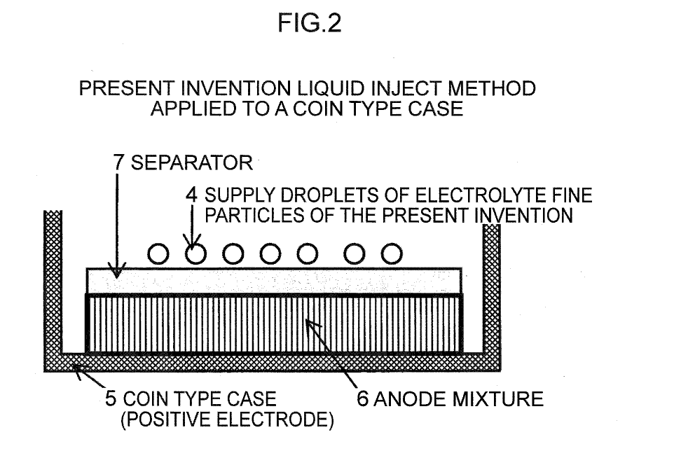

FIG. 1 illustrates a first exemplary embodiment, configured with a cathode mixture 2 housed in a cap 1 made from stainless steel (SUS 304), such that a high viscosity electrolyte that has been converted into electrolyte fine particles 4 is dispersed and droplet-dripped thereon.
FIG. 2 illustrates a second exemplary embodiment in which an anode mixture 6 is housed in a coin type of case (positive electrode) 5, a separator 7 is stacked thereon, and a high concentration ionic liquid 4 is dispersed and intermittently droplet-dripped on an upper portion thereof.

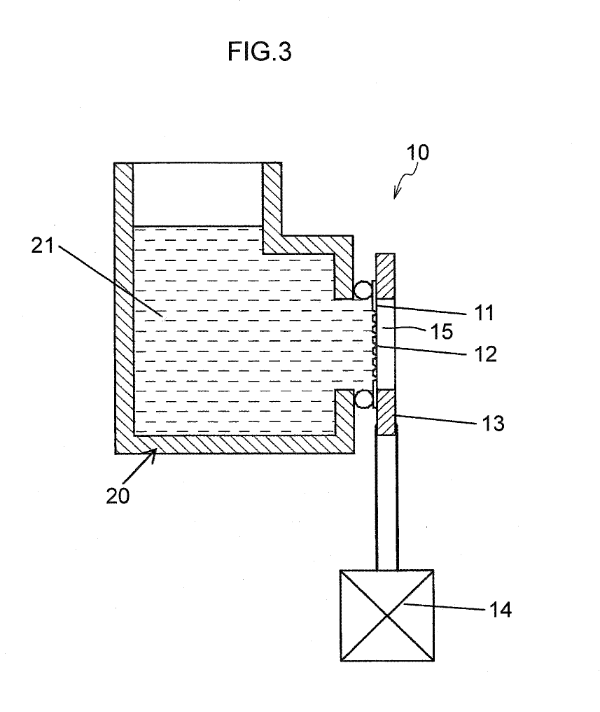

Thus an atomizing spray device 10 as illustrated in FIG. 3 is employed as such a dispersion and droplet-dripping means. The atomizing spray device 10 includes a piezoelectric vibrator (piezoelectric element) 13 that employs BaTiOx to vibrate high viscosity electrolyte using a piezoelectric effect, and at injection ports for dispersion and droplet-dripping employs a method that intermittently droplet-drips fine particles of electrolyte 21 from nozzles 12 with ultrafine holes of 1 to 6000 holes/cm².

In view of resistance to corrosion and chemical resistance to the electrolyte, a nozzle plate 11 is formed by an electro depositing (depositing) method of adding Pd, Co, Mo or the like from an electroforming liquid to a nickel alloy, and forming the nozzles 12 with a hole density of 1 to 6000 holes/cm². The liquid-contacting surfaces of the nozzles 12 and the piezoelectric vibrator 13 are treated with DLC treatment or fluro-treatment to improve their antifriction characteristics, chemical resistance and non-wetting properties.

Detailed explanation follows regarding a first exemplary embodiment of the atomizing spray device 10, based on FIG. 3. The nozzle plate 11 with many nozzles 12 disposed at a pitch of 200 μm produced by electroforming technology with a diameter of 12 μm, and is bonded to the piezoelectric vibrator 13. The high viscosity electrolyte 21 to be atomized and sprayed has a viscosity or about 10 to 40 mPa·s (10 to 40 cps) and is filled in a container 20 on the other side of the nozzle plate 11 in a contact state with the nozzles 12. In this state, the piezoelectric vibrator 13 has impedance characteristics that give a resonance frequency of about 98 kHz and is connected to a pulse generation driving circuit 14 serving as an electrical signal generation means.

Liquid is ejected as liquid droplets from the nozzles 12 by ultrasonic vibration of the electrolyte 21, with the multiple liquid droplets that are generated at each vibration of the piezoelectric vibrator 13 being successively ejected to form an atomized spray. As the viscosity of the electrolyte 21 becomes higher, the liquid droplets cease to separate from the nozzle plate 11 unless the vibration energy is raised.

The inventors have confirmed a phenomenon that for electrolyte 21 that has a high viscosity exceeding 10 mPa·s (10 cps), even when the vibration energy is increase there is still a tendency for the liquid droplets to be pulled back into the nozzle plate 11 before separation occurs and adhere to the nozzle plate 11, with the nozzle plate 11 that has adhered to the electrolyte 21 gradually coagulating, blocking the nozzles 12, and impeding the generation of liquid droplets. This phenomenon does not occur with low viscosity liquids such as those in printers or nebulizers.

As a result of analysis of this phenomenon, it has been found that the electrolyte 21 having a coagulating viscosity wetting and covering the spray outlet side 15 of the nozzles 12 is the cause of the high viscosity electrolyte 21 no longer being atomized. Accordingly, as described above, as a timing to intermittently stop vibration of the piezoelectric vibrator 13, vibration is stopped prior to the viscous electrolyte 21 wetting and covering the spray outlet side 15 of the nozzles 12 due to vibration. Thereby atomization and spraying can be achieved even with the electrolyte 21 having a high viscosity exceeding 10 mPa·s (10 cps).

Moreover, the inventors have also confirmed a phenomenon that as long as there is only a small amount of liquid adhered to the nozzles 12, due to surface tension in the resting state of the nozzles 12, the electrolyte adhered to the nozzles 12 is absorbed and integrated as one with the electrolyte 21 inside the nozzles 12. It has been discovered that liquid droplet generation can be re-started by absorbing and integrating as one during the stopped interval after vibration, then starting the next vibration. It has been discovered that in this absorption and integration phenomenon, for the same volume of adhered electrolyte 21, more time is needed the higher the viscosity, and that it is possible to continue atomization and spraying by not making the rest time shorter as the viscosity gets higher.

The nozzles 12 are thereby suppressed from becoming blocked by the high viscosity electrolyte 21, without the generation of liquid droplets of the high viscosity electrolyte 21 from the nozzles 12 being impeded, thereby enabling the high viscosity electrolyte 21 to be successively atomized and sprayed. Furthermore, despite still employing a simple structure for the liquid supply structure and the atomization and spraying structure, low viscosity electrolyte, as would be expected, and, in particular, the high viscosity electrolyte 21 can also be atomized and sprayed without denaturing or breaking down the electrolyte 21.

The higher the viscosity of the electrolyte 21, the greater the resistance to forming liquid droplets and the more easily the electrolyte 21 adheres to the nozzle plate 11. The adhered electrolyte 21 gradually increases with every vibration. Making the vibration time longer as the viscosity gets higher means that the high viscosity electrolyte 21 can no longer be atomized and sprayed. In order to avoid this, the vibration time is set to 20 ms or less when the viscosity of the electrolyte 21 is 10 mPa·s (10 cps) or greater, and the vibration time is set to 10 ms or less when the viscosity of the electrolyte 21 is 30 mPa·s (30 cps) or greater.

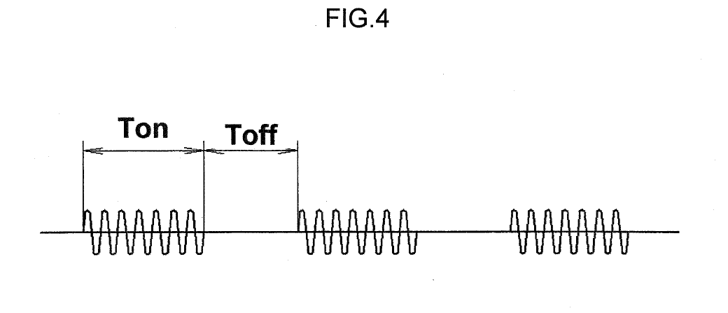

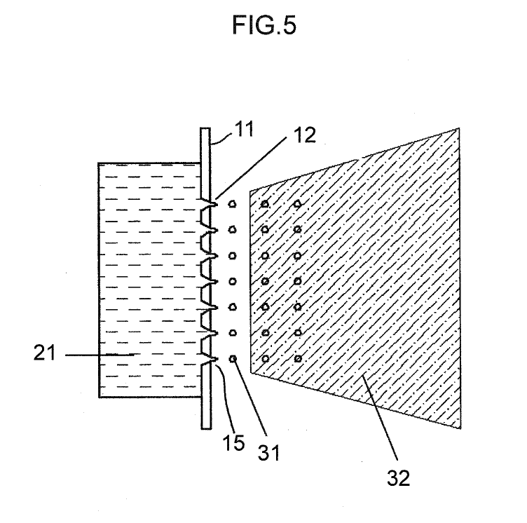

A pulse voltage that drives the piezoelectric vibrator 13 is a sine wave, and the voltage amplitude is about 40V at a frequency of 100 kHz. As illustrated in FIG. 4, successive vibrations with 400 pulses over a period Ton=3 ms followed by stopping for a period of time Toff=10 ms that is equivalent to 1000 pulses are used for units of a pulse voltage pattern, and these units are repeatedly applied to the piezoelectric vibrator 13. Liquid droplets 31 from the nozzles 12 as illustrated in FIG. 5 are generated by vibrations due to the voltage pulse of the piezoelectric vibrator 13, and the high viscosity electrolyte 21 starts to atomize 32.

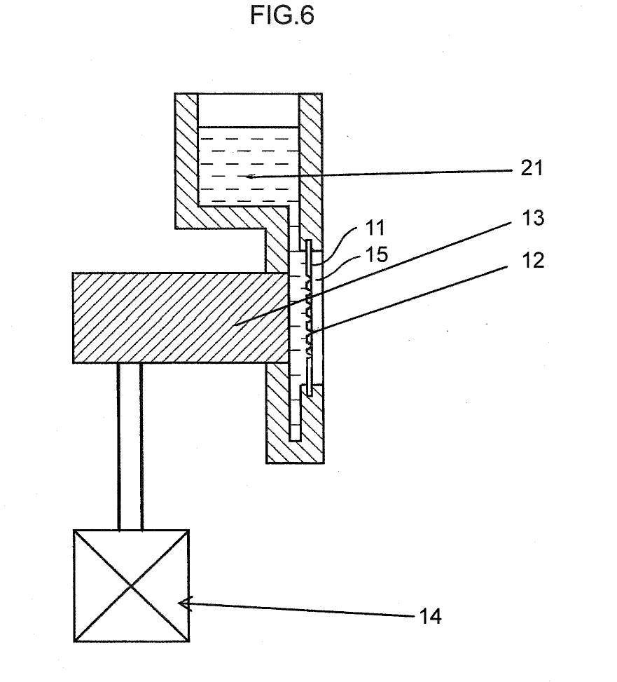

FIG. 6 illustrates a second exemplary embodiment of the atomizing spray device 10, and is a device in which a nozzle plate 12 with nozzles 11 is disposed so as to face towards a piezoelectric vibrator 14, which is a different body. A high viscosity electrolyte 21 is supplied into a gap of from a few tens of μm to a few hundreds of μm between the nozzle plate 12 and the end face of the piezoelectric vibrator 14, and the electrolyte 21 receives the vibration of the end face of piezoelectric vibrator 14 and vibrates. In this device, the mechanism to make the high viscosity 21 and the nozzle plate 11 relatively vibrate is similar to that of the first exemplary embodiment described above, and the operation is also similar.

A fluoro-based water repellent (oil repellent) processing is performed to the surface of the spray outlet side 15 of the nozzle plate 11 in the second exemplary embodiment described above, and similar tests are performed to those of the first exemplary embodiment. Note that the whereas the contact angle of a cosmetic liquid 21 in the first exemplary embodiment without the water repellent processing is about 80 degrees, the contact angle of the high viscosity electrolyte 21 at the surface of the spray outlet side 15 of the nozzle plate 11 in the second exemplary embodiment is about 100 degrees.

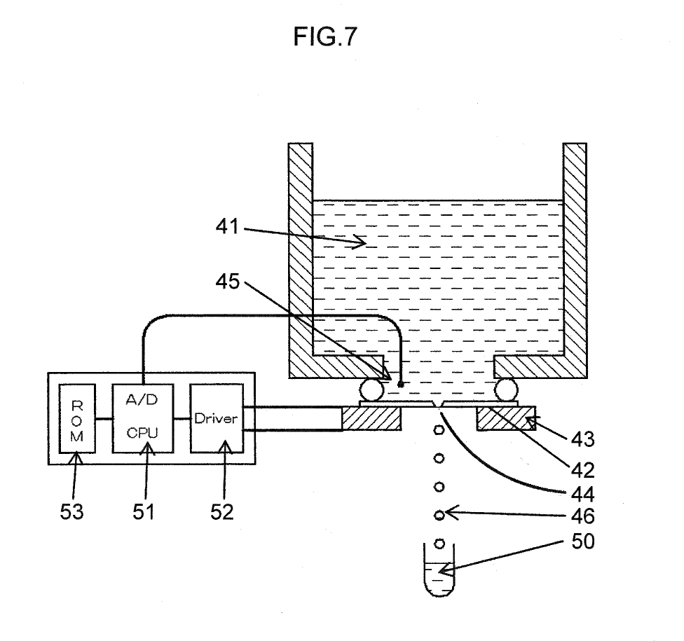

FIG. 7 illustrates a third exemplary embodiment of an atomizing spray device. This device is a high viscosity electrolyte liquid-injection device, and based on the atomizing spray device of the first exemplary embodiment, a liquid 41 to be atomized and sprayed is a high concentration electrolyte, has a single individual nozzle 44 at a center of a nozzle plate 42, and is connected to a vibrator 43. This vibration element is, similarly to in the first exemplary embodiment, repeatedly vibrated and stopped intermittently by a drive circuit 52 that is an electrical signal generation means. A medicinal capsule 50 is disposed below the nozzle 44, and liquid droplets 46 of an electrolyte ejected from the nozzle 44 are injected into the medicinal capsule 50 with a volume of 5 micro liters (μL). During the period that the nozzle plate 42 vibrates, the liquid droplets 46 are ejected as a liquid column in a stream, and the liquid droplet stream is broken during the period when the vibration stops. FIG. 7 is an example of a single individual nozzle, however it is possible to modify to 1 to several individual nozzles according to the concentration and viscosity of the electrolyte and the shape and size of the electrochemical element.

In a cylindrical or square shaped electrochemical element, the precision in the chemical liquid amount of 1 individual battery case needs to be suppressed to ±5%, however the ejected amount per unit time fluctuates with fluctuations in the viscosity due to the electrolyte temperature. The third exemplary embodiment accordingly disposes a thermistor sensor 45 that is a temperature detection means for the viscous liquid in the vicinity of the nozzle plate 42. This temperature sensor resistor is read from an AD conversion input terminal of a micro computer 51, and the micro computer 51 references for computation a conversion table stored on a ROM 53 of ejection rates according to drug solution temperatures, and, in a configuration, includes a determination means that successively determines the ejection duration. The vibrator 43 is vibrated by the drive circuit 52 (electrical signal generation means) with the determined ejection duration as the length of an electrical signal, and as a result the atomization and spraying amount of the viscous liquid is controlled.

Application Example to an Electrochemical Element

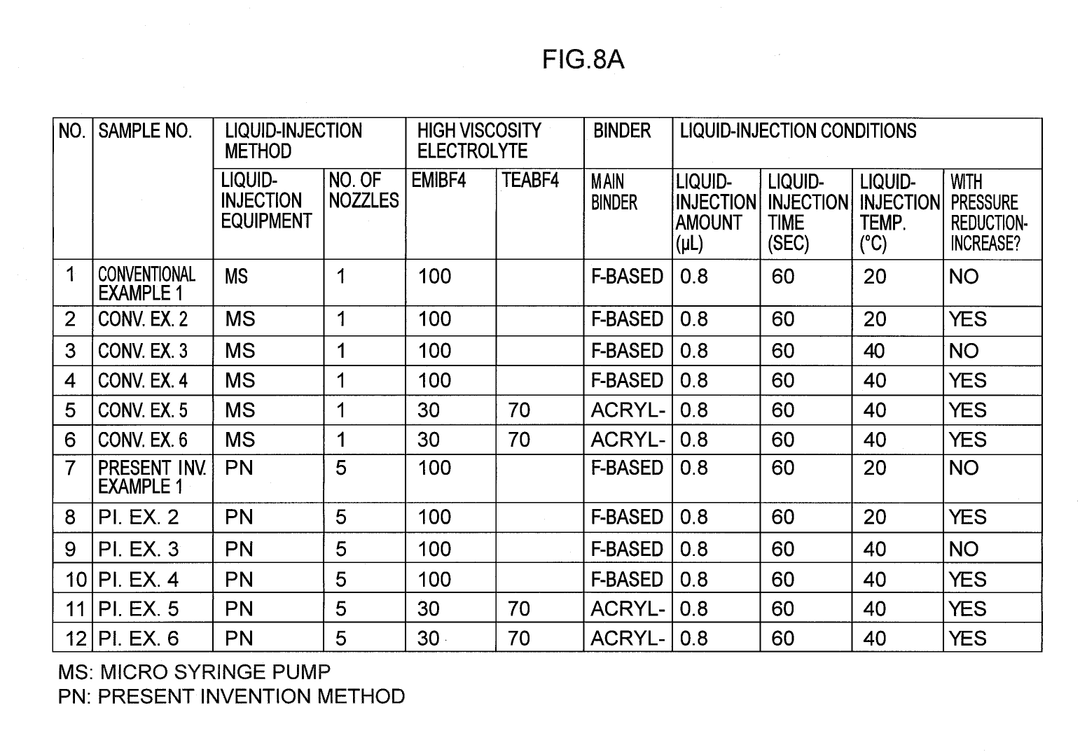

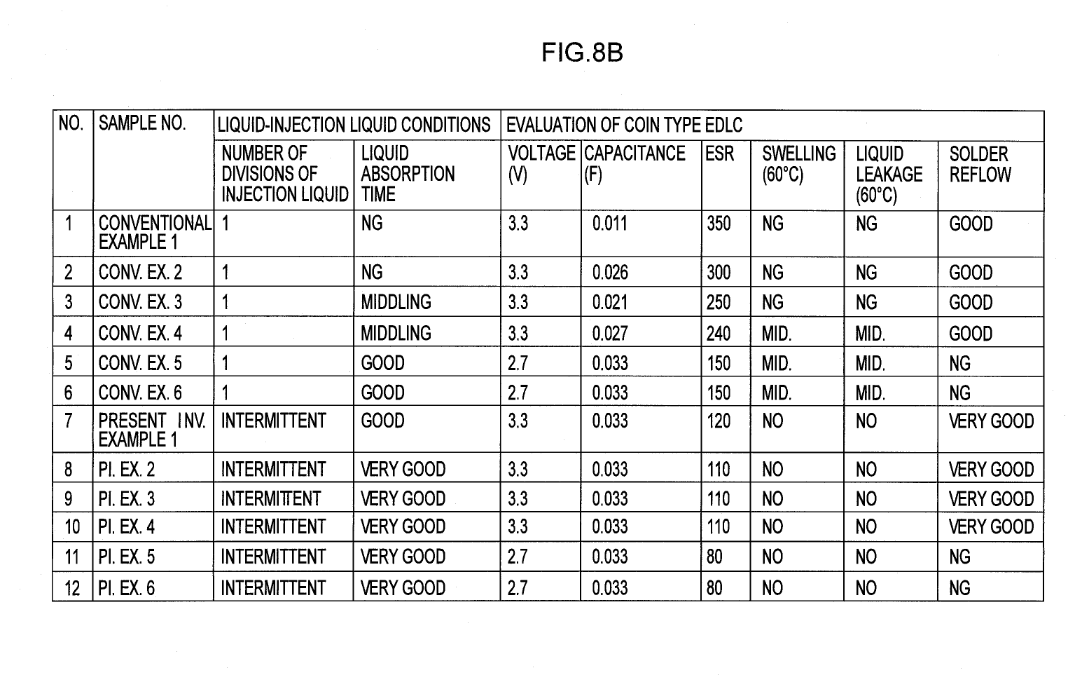

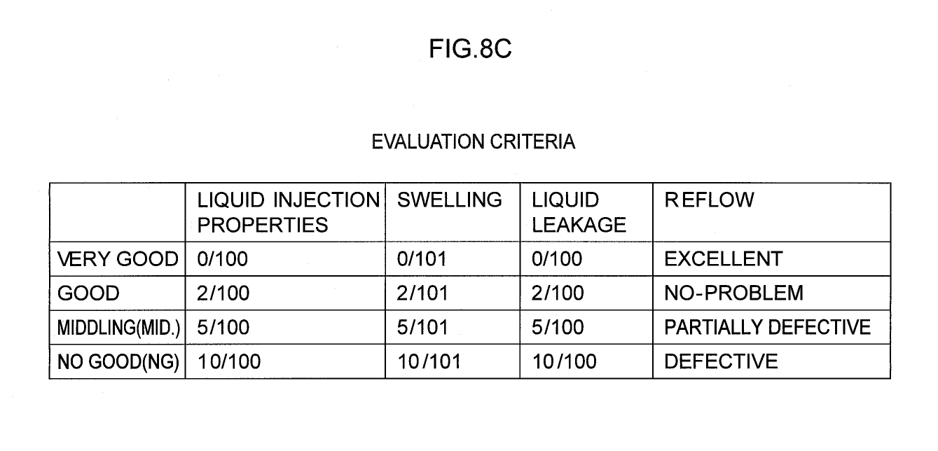

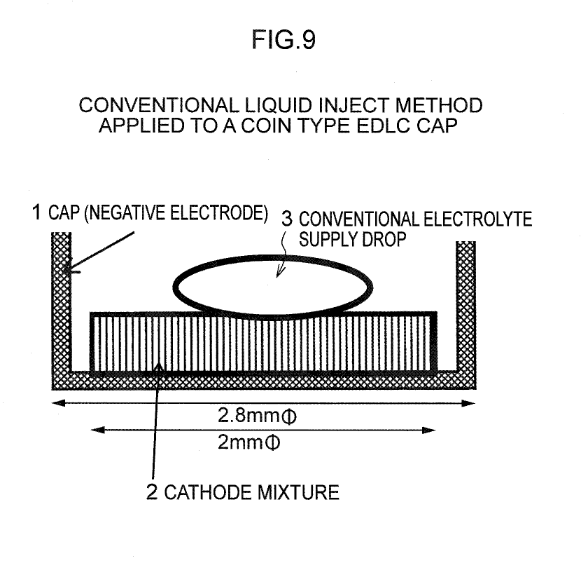

As illustrated in FIG. 8 (8A, 8B and 8C), an evaluation of various characteristics is carried out on a coin type 414 EDLC by comparing Conventional Examples (Nos. 1 to 6) against Examples of the present invention (Nos. 7 to 12), and a detailed description based thereon follows.

EDLC Manufacturing Conditions

1) Activated carbon CEP-21 produced by JX Nippon Oil and Energy and a binder is employed for the EDLC polarized electrodes, and a 450 μm thick activated carbon sheet is produced using a known method, and employed as the cathode and anode.
A fluoro-based binder is employed to give heat resistance to the binder, and an acrylate-based binder is employed in No. 5, 6, 11 and 12.
2) Neat ionic liquid EMTBF4 manufactured by Koei Chemical Company Ltd. is employed as the electrolyte. For comparison purposes a blended liquid with TEABF4 (tetraethylammonium tetrafluoroborate) at (30:70) is employed.
3) A heat resistant separator formed from glass fiber and pulp is employed for the separator. High Concentration Electrolyte Liquid-Injection Conditions
4) Electrolyte supply method: an atomizing spray device as illustrated in FIG. 7 is employed for the method of the present invention, there are 5 of the nozzles with opening diameters of 10 μm, and a liquid-injection amount of 0.8 μL is intermittently injected. A micro syringe pump is employed in the conventional method, with 1 nozzle injecting continuously.
5) Liquid-injection temperature: liquid-injection is performed at 20° C. and 40° C. for a high viscosity liquid-injection environment temperature.
6) Pressure reduction-pressure increase conditions during liquid-injection: pressure reduction and pressure increase conditions in conventional equipment are employed.

EDLC Characteristic Evaluation Conditions and Characteristic Evaluation

### 1) Liquid-Injection Conditions and Liquid-Absorption Conditions:

In conventional liquid injection conditions, an EDL active carbon polarized electrode employs a blended binder of a fluoro-based binder and an acrylate-based binder to achieve heat resistant properties in the binder, and the liquid absorption properties are relatively poor due to continuous liquid injection with a single nozzle. However, in the present invention, 5 nozzles are employed and the liquid absorption state is superior due to the intermittent liquid injection.

### 2) Coin Type EDLC Characteristic Evaluation:

2.7V and 3.3V are exhibited as the voltages of the EDLC irrespective of the liquid injection quantity, and it is easily seen that other various characteristics are proportional to the liquid injection and absorption amounts of the electrolyte.
Namely, when dispersion and liquid injection is performed as in the example of the present invention with multi-hole nozzles in a multiple fine hole system, as illustrated in FIG. 1 and FIG. 2, the liquid injection amount is dispersed and diffused into the electrode mixture 2, and since penetration diffusion of the liquid towards the inside and release of gas that is absorbed within the mixture occur smoothly, it is easy to confirm that a good result is exhibited for an accelerated liquid leakage test and for swelling at 60° C.

Other Applications to Electrochemical Elements

An example is given above of a coin type EDLC as an application example of the present invention, however as other applications of the present invention, similar results are confirmed for coin types, chip types, roll types, circular cylindrical types of other electrochemical elements such as primary cells, secondary cells and pseudo capacitors.

### INDUSTRIAL APPLICABILITY

With the rapid proliferation of smartphones, there is a demand for extremely rapid electrical charging and discharging even in ultra-small EDLCs, and small coin EDLCs are being mass produced. There is also demand to increase production of large secondary cells and large EDLCs such as for HEVs and PEVs.

Currently the greatest problem with high performance electrochemical elements is the problem of liquid injection using high viscosity, high concentration organic electrolytes for mass production.
According to the present invention, the surface tension of a high viscosity electrolyte is reduced by intermittent liquid injection from plural nozzles with multiple fine holes, and there is also no re-coagulation during droplet-dripping. Therefore, since dispersion and diffusion into the electrode mixture and gas-liquid exchange occurs smoothly, improving the liquid injection speed, an electrochemical element can be provided in which an improvement is achieved in line speed of about twice as much, from 50 to 60 ppm to 110 to 120 ppm, and in which accelerated high temperature testing confirms there to be no swelling or liquid leakage, with this having an extremely high value to industry.

### EXPLANATION OF THE REFERENCE NUMERALS

10 atomizing spray device
11, 42 nozzle plate
12, 44 nozzles
13 piezoelectric vibrator
14 pulse generation driving circuit (electrical signal generation means)
15 spray outlet side
21, 41 electrolyte
43 vibrator
45 thermistor sensor (temperature detection means)
51 micro computer (determination means)
52 drive circuit (electrical signal generation means)

1. An electrochemical element, wherein predetermined minute amounts of an electrolyte are rapidly supplied with dispersed condition.

2. The electrochemical element of claim 1, wherein said electrochemical element is any one of a primary cell, a secondary cell, an electric double-layer capacitor, or a pseudo electric double-layer capacitor.

3. The electrochemical element of claim 1, wherein said electrolyte has a high viscosity of 10 to 40 mPa·s at 20° C.

4. The electrochemical element of claim 1, wherein a vibration element is employed to intermittently supply said electrolyte from nozzles with spray holes at a density of 1 to 6000 holes/cm² as a means for said supply with dispersed condition.

5. The electrochemical element of claim 4, wherein the hole diameter of the spray holes of said nozzles formed in a nickel based alloy metal is in a range of 1 to 100 μm.

6. The electrochemical element of claim 4, wherein surface treatment is performed to the surface of said spray holes to achieve excellent abrasion resistance properties, chemical resistance properties and non-wetting resistance properties.

7. The electrochemical element of claim 6, wherein said surface treatment is diamond-like carbon (DLC) processing or fluoro-processing.

8. The electrochemical element of claim 4, wherein a duration of the vibration is 20 ms or less when the viscosity of said electrolyte is 10 mPa·s or above, and the duration of the vibration is 10 ms or less when the viscosity of said electrolyte is 30 mPa·s or above.

9. The electrochemical element of claim 4, comprising:
a nozzle plate that contains said nozzles and is supplied with the electrolyte; and
comprises an atomizing spray device for said supply with dispersed condition that includes a vibrator that vibrates said nozzles and a means for generating an electrical signal that intermittently vibrates said vibrator, wherein said atomizing spray device intermittently stops the vibration of said vibrator before a spray outlet side of said nozzles is wetted and covered by said electrolyte; and
wherein metered supply of said electrolyte is intermittent.

10. The electrochemical element of claim 9, wherein said atomizing spray device includes a detection means that detects the temperature of said electrolyte, and a determination means that determines the length of said electrical signal according to the detected temperature, wherein an electrolyte amount that is atomized and sprayed from said nozzles is controlled by the length of said electrical signal.

11. The electrochemical element of claim 9, wherein said nozzle plate has a separation between adjacent said nozzles of 150 μm or greater.
